(19) United States
(12) Patent Application Publication
(10) Pub. No.: US 2014/0214192 A1
(43) Pub. Date: Jul. 31, 2014

(54) Apparatus For Design-Based Manufacturing Optimization In Semiconductor Fab

(71) Applicant: DMO SYSTEMS LIMITED, Hsinchu county (TW)

(72) Inventors: Shauh-Teh Juang, Saratoga, CA (US); Jason Zse-Cherng Lin, Saratoga, CA (US)

(73) Assignee: DMO SYSTEMS LIMITED, Hsinchu county (TW)

(21) Appl. No.: 13/749,682

(22) Filed: Jan. 25, 2013

(51) Int. Cl. G06Q 10/06

(52) U.S. Cl. 700/105

(57) ABSTRACT

A design-based manufacturing optimization (DMO) server comprises a distributed computing system and a DMO software module incorporating with a design scanner to scan and analyze design data of a semiconductor device for optimizing manufacturing of the semiconductor device. The DMO software module sets up a pattern signature database and a manufacturing optimization database, generates design-based manufacturing recipes, interfaces with manufacturing equipment through a manufacturing interface module, and interfaces with electronic design automation suppliers for the design data through a design interface module. The DMO server executes the design-based manufacturing recipes for manufacturing optimization.

### BACKGROUND OF THE INVENTION

1. Field of the Invention

The present invention relates generally to semiconductor manufacturing, and more particularly to an apparatus for optimizing semiconductor manufacturing based on design.

2. Description of Related Arts

Producing semiconductors requires a very cost-intensive and sophisticated manufacturing environment. With the size of the structures built on a semiconductor chip decreasing, the production costs are increasing at the same pace. Semiconductor production in a modern fab requires several hundreds of machines, with prices reaching several ten-millions or even hundred-millions of US dollars per machine.

The process of integrated circuit (IC) manufacturing often requires hundreds of sequential steps, each one of which could lead to yield loss. Consequently, maintaining product quality in a semiconductor manufacturing facility often requires the strict control of hundreds or even thousands of process variables. The issues of high yield, high quality and low cycle time are being addressed in part by the ongoing development of several critical capabilities, i.e. process monitoring, process/equipment modeling, process optimization, process control, equipment and process diagnosis and parametric yield modeling.

Advanced process control is widely used in semiconductor manufacturing to adjust machine parameters so as to achieve satisfactory product quality. However, huge amount of data are generated each day from hundreds of equipments, it is difficult to extract hidden relationships between numerous complex process control parameters. In recent years, data mining approach has also been proposed to discover correlated parameters for yield enhancement in semiconductor manufacturing.

As the advanced semiconductor technology pushes the physics limits to shrink the size of the device, there is ever-increasing inter-dependency between device design and device manufacturing process. However, the inter-dependency has rarely been utilized to optimize the semiconductor manufacturing process because of the availability of the device design data and the security concern in exposing the device design data in the manicuring flow of the semiconductor process.

There is a strong need for providing an integrated, secure and systematic solution in the semiconductor fab for manufacturing optimization based on design to reduce the ever-increasing cost of ownership from process development to high-yield production.

### SUMMARY OF THE INVENTION

The present invention has been made to meet the above mentioned need and challenges in advanced semiconductor manufacturing. Accordingly, the present invention provides a fault-tolerant, highly scalable and secure server that focuses on the complex inter-dependency of device design and manufacturing for achieving efficient semiconductor fab operation.

In accordance with the present invention, the design-based manufacturing optimization (DMO) server comprises a distributed computing system and a DMO software module incorporating with a design scanner to scan and analyze design data of a semiconductor device for optimizing recipes of manufacturing the semiconductor device with reference to a pattern signature data base and a manufacturing optimization database.

The DMO server of the present invention further includes a design interface module for interfacing with electronic design automation (EDA) software and design flow/data and a manufacturing interface module for interfacing with equipment and manufacturing flow/data. The operations of the DMO can be categorized into off-line setup mode, in-line production mode and data review mode.

In the off-line setup mode, the DMO software module sets up the pattern signature database of comprehensive design patterns and, pattern signatures of the semiconductor device for use in the in-line production mode. The DMO software module also analyzes the design data to set up multi-level definitions of design signatures for the pattern signature database. The DMO software module further sets up the manufacturing optimization database that comprises rules, algorithms and templates in sync with the pattern signature database for in-line production mode.

In the in-line production mode, the DMO software module fetches the design data and provides secure access control for the design data, interfaces with equipment and manufacturing flow through the manufacturing interface module and interfaces with electronic design automation suppliers for the design data through the design interface module. The DMO software module also processes the design data to extract design signature and generate manufacturing recipes with reference to the pattern signature database and the manufacturing optimization database.

In the data review mode, the output data generated by running the manufacturing recipes in the in-line production mode and saved in the distributed file system can be fetched for review. The DMO software module provides statistical data and trends of monitoring pattern signatures during a time window based on the output data. A data mining approach is also used to discover inter-dependency between device design, equipment efficiency and manufacturing yield for the data review.

### BRIEF DESCRIPTION OF THE DRAWINGS

The present invention will be apparent to those skilled in the art by reading the following detailed description of preferred embodiments thereof, with reference to the attached drawings, in which:

FIG. 1 shows a block diagram of a design-based manufacturing optimization server according to the present invention;

FIG. 2 shows a block diagram of the distributed computing system in the design-based manufacturing optimization server according to the present invention;

FIG. 3 shows the three major operations of the design-based manufacturing optimization server according to the present invention;

FIG. 4 shows the major functions of the off-line setup mode.

FIG. 5 shows the major functions of the in-line production mode.

FIG. 6 shows examples of recipes generated for design-based manufacturing optimization.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

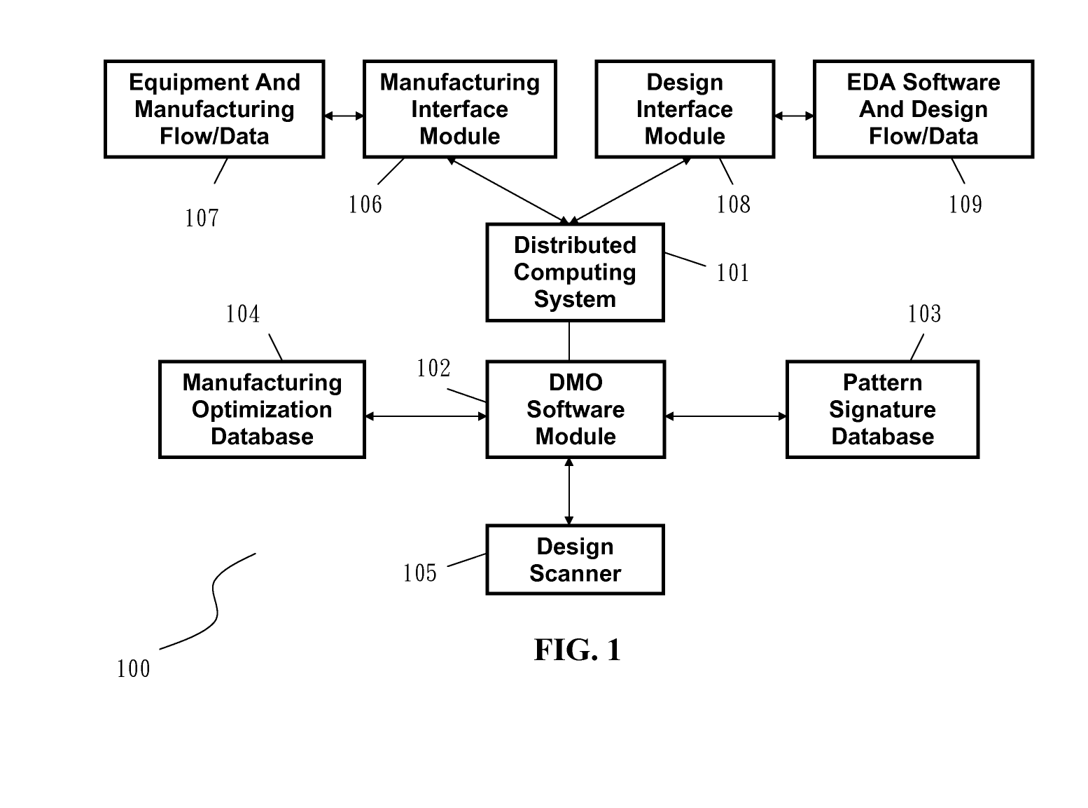

FIG. 1 shows a block diagram of the integrated design-based manufacturing optimization (DMO) server 100 according to the present invention. The DMO server 100 comprises a distributed computing system 101 and a DMO software module 102. The DMO server 100 further has a pattern signature database 103 and a manufacturing optimization database 104 and a designer scanner 105. The distributed computing system 101 is connected to a design interface module 108 to communicate with EDA software and design flow 109, and a manufacturing interface module 106 to communicate with equipment and manufacturing flow 107.

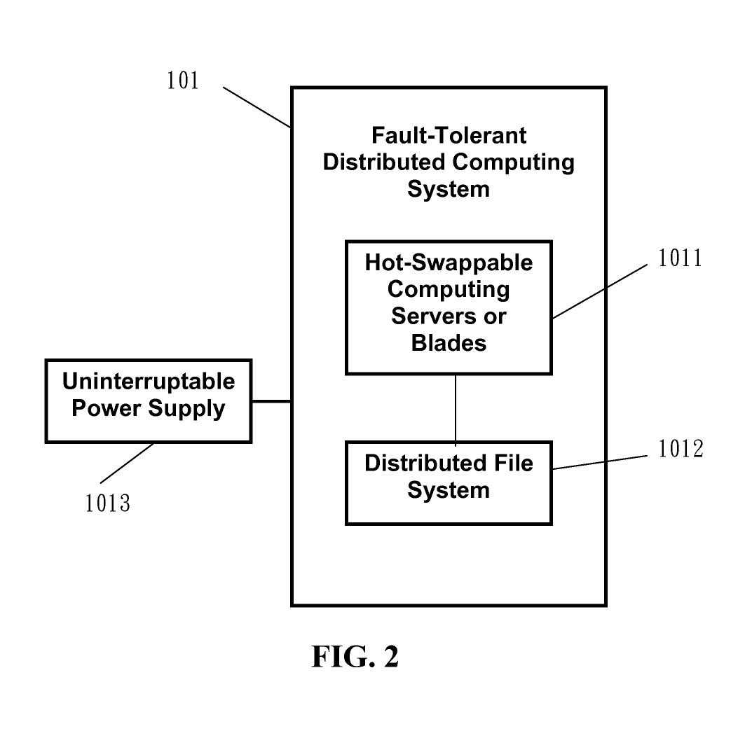

As shown in FIG. 2, the distributed computing system 101 is a fault-tolerant distributed computing system comprising a plurality of redundant and hot-swappable computing devices such as blades or servers 1011 and a distributed file system 1012 having a plurality of data storage devices. The distributed file system 1012 may have its own dedicated file servers to manage and control the data storage devices of the distributed file system 1012 or use the same computing blades or servers 1011 for file system management.

Preferably, an uninterruptible power supply 1013 is connected to the distributed computing system 101 so that the distributed computing system 101 can operate uninterruptedly in a fab environment. The distributed computing system 101 has a highly scalable architecture in which the number of computing blades or servers 1011 can be easily increased to increase computing power, and the number of storage devices can also be easily increased to add storage capacity. In addition, the distributed computing system 101 is a secure computing system that requires different levels of authentication to obtain different levels of privileges for operation and data access.

The DMO software module 102 is executed in the computing blades or servers 1011 for providing different operations including security authentication, recipe generation, flow integration, database setup and management, job distribution, and so on.

In one preferred embodiment of the present invention, the DMO server 100 is connected through the manufacturing interface module 106 to a wafer inspector to optimize manufacturing by design-based binning. The DMO server 100 handshakes with the wafer inspector to receive wafer inspection data and then executes design-based binning jobs based on design-based binning recipes that have been set up to identify yield sensitive design patterns. As soon as an inspection result is available, the DMO software module 102 prepares a design-based binning job by including the inspection result, the design-based binning recipe, and the design data associated with the inspected wafer, and then distributes the job to the plurality of computing blades or servers for execution.

The design scanner 105 is a high-throughput design data analyzer that can perform full-chip design scanning and partitioning for various design data operations such as pattern searching, matching, classification and grouping. The design data operations may use the design data of one or more layers. Algorithms used for pattern searching, matching, classification and grouping may be pattern-based or rule-based.

The pattern signature database 103 contains the design patterns and signatures of critical layouts or yield hot spots. The design patterns and signatures may be used in job recipes for design pattern grouping and classification to assist process and performance monitoring. The manufacturing optimization database 104 contains the rules, algorithms and templates for manufacturing recipe generation for equipment tooling, process monitoring, performance monitoring, yield monitoring, and feedback tuning, etc.

The manufacturing interface module 106 interfaces with the equipment and manufacturing flow 107 of fab operations to receive manufacturing data and the design interface module 108 interfaces with EDA software and design flow 109 of design operations and also obtain design data from design database.

It is worth mentioning that the manufacturing interface module 106 of the present invention can be used to interface with multiple manufacturing machines in the manufacturing flow 107. The DMO software module 102 is responsible for preparing jobs as soon as the output data from manufacturing machines are available. Based on the manufacturing recipe set up for each manufacturing machine, different type of jobs may be created for different manufacturing machines. The DMO software module 102 distributes the jobs among the plurality of computing blades or servers and balances the computing loads.

In a semiconductor fab, various photomasks are used for manufacturing different device layers in the semiconductor manufacturing. Therefore, mask making operation plays an important role in the semiconductor manufacturing. The DMO server of the present invention can also be used in the optimization of mask writing and inspection based on critical signatures and patterns in the design data. In other words, the manufacturing interface 106 can interface with mask making machines or inspectors in the manufacturing flow 107.

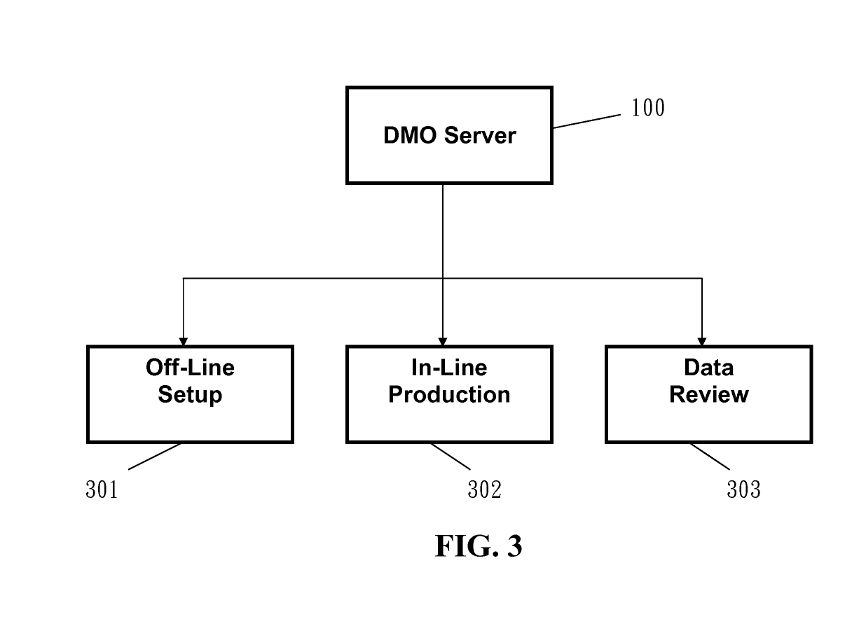

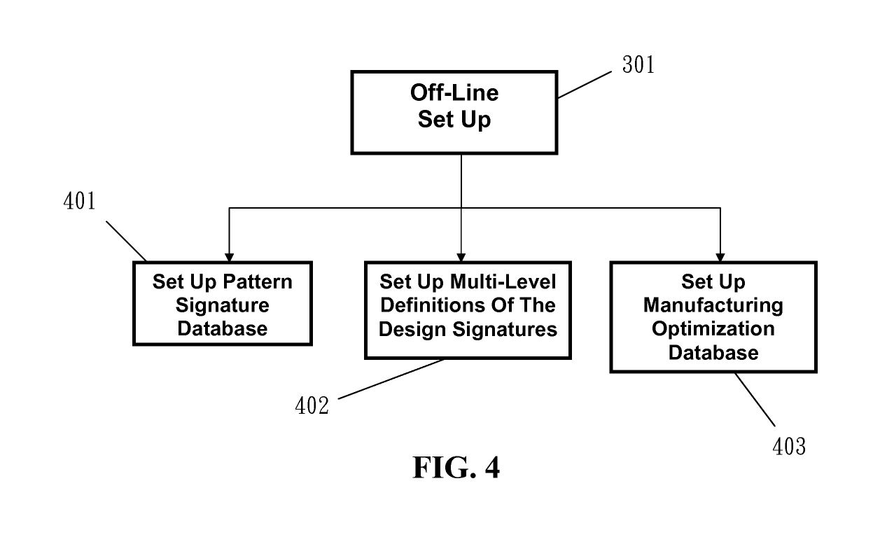

In accordance with the present invention, the operations of DMO server can be categorized into three major user modes, i.e., off-line setup 301, in-line production 302 and data review as shown in FIG. 3. In the off-line setup mode 301, the DMO server 100 has a few primary functions. As shown in FIG. 4, the first function 401 is to set up the pattern signature database 103 of comprehensive design layout patterns and pattern signatures for subsequent in-line production use.

The pattern signature database 103 comprises design patterns that are critical to manufacturing optimization. For example, hotspot patterns validated by wafers, fixed hotspots, status of hotspots, weak patterns from optical proximity correction (OPC) and process simulations, yield and process window sensitive pattern signatures including special 2D/3D multi-layer via, transistor, small metal, and line-end patterns, and good patterns that are yield and process window safe are all saved in the database. Pattern search templates, rules and constraints to be incorporated in the manufacturing recipes are included in the database.

The second function 402 is to analyze the design data so as to set up multi-level definitions of the design signatures for the pattern signature database. For example, the design area may be partitioned into memory, logic, analog, input/output, or dummy areas. Pattern density map may be generated to identify dense and sparse areas. The design data may also be analyzed to find the distribution of good pattern signature, yield and process window sensitive pattern signature, weak pattern signature and hotspot.

The third function 403 is to set up the manufacturing optimization database 104 that consists of rules, algorithms and templates in sync with the pattern signature database for the manufacturing recipe generation for subsequent in-line production use.

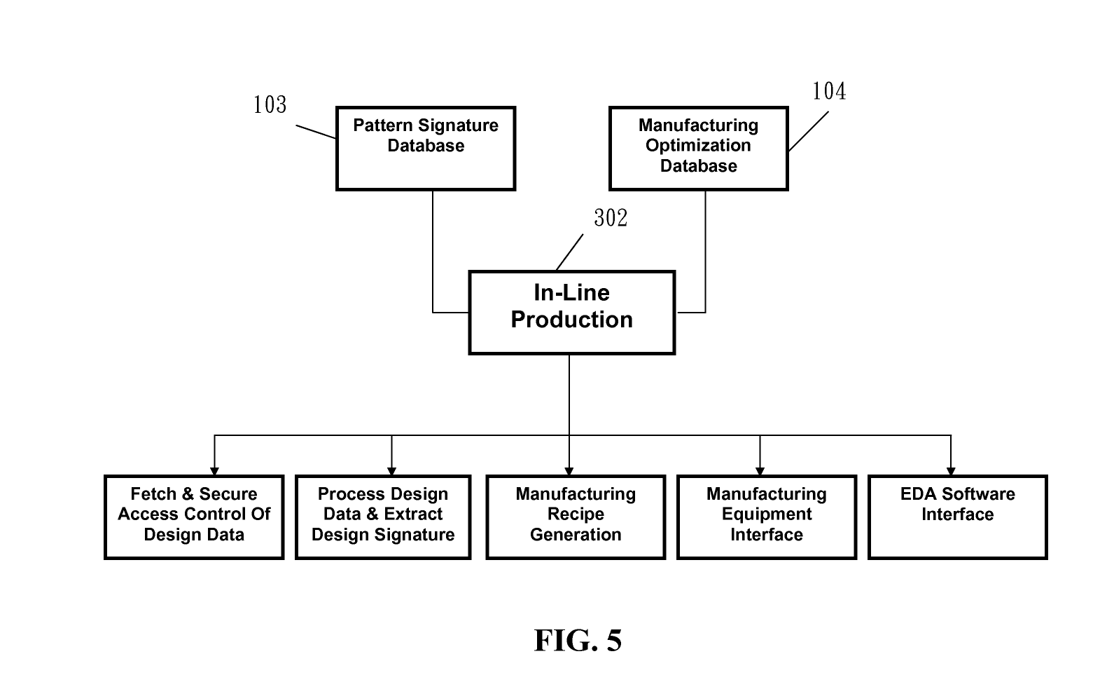

FIG. 5 shows the major functions performed in in-line production mode 302. In the in-line production mode 302, the DMO server 100 has to fetch the design data for the incoming device in the manufacturing flow for production use and provide secure access control. The design data have to be processed to extract the design signatures based on the pattern signature database 103 established in off-line setup. The extracted design signatures and the established manufacturing optimization database 104 are used to generate manufacturing recipes for improving equipment efficiency, process control and process yield.

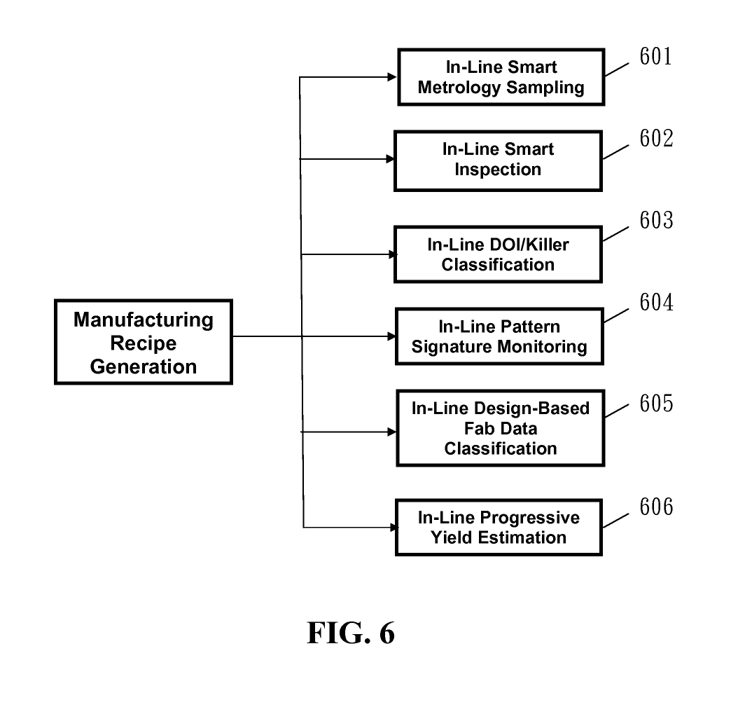

As shown in FIG. 6, based on the design-linked criticalities, the manufacturing recipes may include in-line smart metrology sampling 601 with optimized defect of interest (DOI) and systematic defect coverage, in-line smart inspection 602 with multi-sensitivity and mixed-tool setup and in-line DOI and killer defect classification 603. The manufacturing recipes may also be generated for in-line hotspot, weak and sensitive pattern signature monitoring 604 by defect correlation, in-line progressive yield estimation 606 or in-line design-based fab data classification 605 for effective off-line data analysis.

During the in-line production, the DMO server 100 interfaces to manufacturing equipment and information system in the manufacturing flow via scripts, files and databases through direct communication link or internet link for seamless integration of device manufacturing process. The DMO server 100 also interfaces with EDA software and information system in the design flow via scripts, files and databases through internet link for seamless integration of device design environment.

According to the present invention, the DMO server 100 also provides a data review mode 303 for users to do data review. Data review provides important feedback for setting up the manufacturing recipes to optimize the manufacturing. The job outputs from running the manufacturing recipes described above are saved in the distributed file system 1012 and can be fetched for review.

In the present invention, data mining approach is also used to discover critical inter-dependency among the device design, equipment efficiency and yield. In the off-line mode 303, a user can review the inter-dependency to identify systematic solution for yield enhancement. In addition, various statistical data can also be derived from the job outputs. For example, various

trend and histogram data in a time window such as weekly or monthly from the result of hotspot, weak and sensitive pattern signature monitoring based on die or wafer basis can be reviewed.

In summary, the present invention provides a DMO server in the semiconductor fab to facilitate an integrated and systematic solution for design-based optimization of device manufacturing that covers equipment efficiency, process diagnostics, process tuning, process monitoring, performance monitoring and yield enhancement by using the inter-dependency between device design and device manufacturing process.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A designed-based manufacturing optimization server, comprising:
a distributed computing system;
a design scanner; and
a design-based manufacturing optimization software module executed in said distributed computing system;
wherein said design-based manufacturing optimization software module uses said design scanner to scan and analyze design data of a semiconductor device for optimizing recipes in manufacturing flow of manufacturing said semiconductor device.

2. The design-based manufacturing optimization server as claimed in claim 1, wherein said distributed computing system is a fault-tolerant distributed computing system comprising a plurality of hot-swappable computing devices and a distributed file system.

3. The design-based manufacturing optimization server as claimed in claim 2, wherein said distributed file system is controlled and managed by said hot-swappable computing devices.

4. The design-based manufacturing optimization server as claimed in claim 2, wherein said distributed file system is controlled and managed by a plurality of dedicated file servers different from said hot-swappable computing devices.

5. The design-based manufacturing optimization server as claimed in claim 1, further comprising a design interface module for interfacing with electronic design automation software for fetching said design data.

6. The design-based manufacturing optimization server as claimed in claim 5, further comprising a pattern signature database.

7. The design-based manufacturing optimization server as claimed in claim 6, further comprising a manufacturing interface module for interfacing with said manufacturing flow.

8. The design-based manufacturing optimization server as claimed in claim 7, wherein said manufacturing interface module interface with multiple manufacturing machines in said manufacturing flow.

9. The design-based manufacturing optimization server as claimed in claim 7, further comprising a manufacturing optimization database.

10. The design-based manufacturing optimization server as claimed in claim 9, wherein said design-based manufacturing optimization server includes off-line setup mode, in-line production mode and data review mode.

11. The design-based manufacturing optimization server as claimed in claim 10, wherein in said off-line setup mode, said design-based manufacturing optimization software module sets up a pattern signature database of comprehensive design patterns and pattern signatures of said semiconductor device for use in said in-line production mode.

12. The design-based manufacturing optimization server as claimed in claim 11, wherein said pattern signature database includes design patterns and pattern signatures of hotspot patterns critical to manufacturing said semiconductor device, weak patterns from optical proximity correction and process simulation, yield and process window friendly patterns, and yield and process window sensitive patterns.

13. The design-based manufacturing optimization server as claimed in claim 11, wherein said pattern signature database further stores pattern templates, rules and constraints of using said design patterns and pattern signatures in said in-line production mode.

14. The design-based manufacturing optimization server as claimed in claim 10, wherein in said off-line setup mode, said design-based manufacturing optimization software module analyzes said design data to set up multi-level definitions of design signatures for said pattern signature database.

15. The design-based manufacturing optimization server as claimed in claim 14, wherein said multi-level definitions of design signatures include design area partitions, pattern map density, good pattern signature distribution, yield and process window sensitive pattern signature distribution, weak pattern signature distribution and hotspot distribution.

16. The design-based manufacturing optimization server as claimed in claim 10, wherein in said off-line setup mode, said design-based manufacturing optimization software module sets up said manufacturing optimization database.

17. The design-based manufacturing optimization server as claimed in claim 16, wherein said manufacturing optimization database comprises rules, algorithms and templates in sync with said pattern signature database for said in-line production mode.

18. The design-based manufacturing optimization server as claimed in claim 10, wherein in said in-line production mode, said design-based manufacturing optimization software module fetches said design data and provides secure access control for said design data.

19. The design-based manufacturing optimization server as claimed in claim 10, wherein in said in-line production mode, said design-based manufacturing optimization software module interfaces with manufacturing equipment through said manufacturing interface module.

20. The design-based manufacturing optimization server as claimed in claim 10, wherein in said in-line production mode, said design-based manufacturing optimization software module interfaces with electronic design automation suppliers for said design data through said design interface module.

21. The design-based manufacturing optimization server as claimed in claim 10, wherein in said in-line production mode, said design-based manufacturing optimization software module processes said design data to extract design signature and generate manufacturing recipes with reference to said pattern signature database and said manufacturing optimization database.

22. The design-based manufacturing optimization server as claimed in claim 21, wherein in said in-line production mode, said manufacturing recipes include recipes for in-line metrology, in-line inspection, in-line defect classification and in-line progressive yield estimation.

23. The design-based manufacturing optimization server as claimed in claim 10, wherein a data mining approach is used to discover inter-dependency between device design, equipment efficiency and manufacturing yield for said data review.

24. The design-based manufacturing optimization server as claimed in claim 10, wherein statistical data and trend of monitoring pattern signatures during a time window are presented in said data review mode.

25. The design-based manufacturing optimization server as claimed in claim 7, wherein said manufacturing interface module interfaces with a wafer inspector in said manufacturing flow for optimizing recipes of wafer inspection based on said design data.

26. The design-based manufacturing optimization server as claimed in claim 7, wherein said manufacturing interface module interfaces with a wafer metrology equipment in said manufacturing flow for optimizing recipes of wafer metrology based on said design data.

27. The design-based manufacturing optimization server as claimed in claim 7, wherein said manufacturing interface module interfaces with a mask writer in said manufacturing flow for optimizing recipes of mask writing based on said design data.

28. The design-based manufacturing optimization server as claimed in claim 7, wherein said manufacturing interface module interfaces with a mask inspector in said manufacturing flow for optimizing recipes of mask inspection based on said design data.
